(19) United States
(12) Patent Application Publication
(10) Pub. No.: US 2010/0015398 A1
(43) Pub. Date: Jan. 21, 2010

(54) Substrate with Partition Pattern and Process for Producing the Same

(75) Inventors: Junichi Kaminaga, Tokyo (JP); Hiroyuki Miura, Tokyo (JP); Takeshi Ikeda, Tokyo (JP); Yuji Kubo, Tokyo (JP); Eishi Aoki, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing C0. Ltd, Tokyo (JP)

(21) Appl. No.: 12/305,938

(22) PCT Filed: Jun. 19, 2007
(86) PCT No.: PCT/JP2007/062321

§ 371 Date: Mar. 24, 2009

(30) Foreign Application Priority Data
Jun. 20, 2006 (JP) 2006-170047

(51) Int. Cl. G02B 5/20; B32B 3/02; B05D 3/06

(52) U.S. Cl. 428/166; 427/533; 349/189

(57) ABSTRACT

One embodiment of the present invention is a substrate with a partition wall pattern, the partition wall pattern formed on a predetermined position of the substrate, the partition wall pattern having a material including a fluorine compound, wherein a ratio of a detected intensity of a fragment ion of F⁻ (M/Z=19) to total detected intensity of all minus ions is 25%-60% in the case where analysis of minus ions of an upper surface of the partition wall is performed using a time-of-flight secondary ion mass spectrometry (TOF-SIMS).

### BACKGROUND OF THE INVENTION

1. Field of the Invention

The present invention relates to a substrate with a partition wall used for a liquid crystal display device or an electroluminescence display device and relates to a method for manufacturing the substrate with the partition wall. In more detail, the present invention relates to a substrate with a partition wall, the substrate's respective pixels formed by an ink jet printing, and relates to a method for manufacturing the substrate with the partition wall.

2. Description of the Related Art

A color filter used for a color liquid crystal display device etc. is a necessary component for a color liquid crystal display device etc. A color filter has a role of improving an image quality of a liquid crystal display device or a role of providing elementary colors for respective pixels. Various methods for manufacturing a color filter are studied. As representative methods, a photolithography method and an ink jet method and the like are known. In a photolithography method, coated films of photosensitive resin layers of respective colors are applied to the entire substrate, and unnecessary parts of coated films are removed, and the remaining patterns are used for pixels of respective colors. In this method, most of a coated film is not necessary. Therefore, a large amount of material such as a pigment is wasted in manufacturing a color filter. In addition, for a pixel of each color, exposure and development are performed. Therefore, the number of processes is large. Therefore, manufacturing a color filter by lithography has a problem in view of both cost and the environment. In this point, an ink jet method is attracting attention. In manufacturing a color filter by an ink jet method, color resin compositions of three colors are used for inks and printing of the respective colors can be simultaneously performed. Therefore, there is little waste of material and in addition, processes for forming a pixel are reduced. Therefore, it is possible to expect a significant reduction in environment load and costs.

As a method for manufacturing a color filter substrate by an ink jet method, methods described in patent documents 1-4 are proposed. In patent document 1 (JP-A-H06-347637), the following technology is disclosed: for the purpose of preventing an ink from spreading outside of a predetermined colored layer region on a glass substrate, a fluorinated acid type water-repellent/oil-repellent agent is added to a black partition wall part (a black matrix) which sections pixels; a critical surface tension of a partition wall is less than 35 dyne, a critical surface tension of a surface to be printed is equal to or more than 35 dyne wherein the surface to be printed is between partition walls; as for a surface tension of an ink, the difference between a surface tension of an ink and a critical surface tension of a partition wall is equal to or more than 5 dyne, and the difference between a surface tension of an ink and a critical surface tension of a surface to be printed is equal to or more than 5 dyne; and thereby an ink is formed only inside a color region. In addition, in patent document 2 (JP-A-H07-35915), patent document 3 (JP-A-H07-35917) and patent document 4 (JP-A-H07-248413), the following technology is described: a partition wall for preventing ink bleeding and a color mixture is a black resin layer including a fluorine containing compound and/or a silicon containing compound; and a reducing contact angle of the black resin layer to water is equal to or more than 40°, or a reducing contact angle of the black resin layer to a color ink for forming a pixel is equal to or more than 20°. In these methods, since a partition wall is made of a black resin composition including an ink-repellent fluorine compound, it is not necessary to provide an ink-repellent property for a partition wall pattern and to provide a good affinity to ink for a surface to be printed. Therefore, the number of processes is few. Further, the environmental burden and manufacturing cost can be reduced. Therefore, these methods are very preferable.

As other methods, there is the following technology: a pattern of a partition wall material is formed on a substrate, thereby a partition wall pattern is formed; thereafter, a surface processing is performed in order to control an ink-repellent property. In this method, one process is added to the above-mentioned very preferable method. Further, it is difficult to control the degree of an ink-repellent property of upper side surfaces of a partition wall.

In addition, further, there is the following technology: a partition wall material is formed on a substrate; processing an ink-repellent property is performed; thereafter, a pattern of a partition wall is formed. In this method, in a process forming a pattern, an ink-repellent property may be reduced, thereby it is difficult to provide a predetermined ink-repellent property for a partition wall.

However, in the above conventional methods, the following problems occurred: printing is performed using a pigment dispersion type color ink with an organic solvent by an ink jet method; then an ink moves over a partition wall toward an adjacent pixel; a color mixture occurs; and, reversely, a color omission occurs. In addition, even if a surface of a partition wall has a sufficient ink-repellent property to a color ink for forming a pixel, an ink-repellent agent may be decomposed and scattered or may bleed outside of a partition wall in a burning process for forming a partition wall and in a washing process before ink jet printing. Therefore, a substrate surface corresponding to an opening surrounded by partition walls is polluted with an ink-repellent agent. Thereby a color omission of a colored layer occurs and a shape of a pixel does not become flat. Therefore, it was difficult to form a flat pixel without a color mixture and a color omission.

In addition, in order to provide a flat pixel without a color mixture etc., it is necessary to control an ink-repellent property of a partition wall. However, if the upper part of a partition wall has an ink-repellent property, in the case where a functional layer such as an overcoat layer or a conductive layer is formed on a partition wall, adhesion between a partition wall and a functional layer is insufficient, thereby a functional layer does not become uniform or a film peeling of a functional layer occurs.

In order to avoid this, it is thought that a partition wall without an ink-repellent property is formed. However, in this case, adhesion between a partition wall and a functional layer becomes sufficient. On the other hand, a color mixture or a color omission occurs and therefore a flat pixel can not be formed.

That is, it was difficult to realize both a flat pixel without a color mixture and a color omission, and a uniform functional layer in which a film peeling does not occur.

The present invention is to provide a substrate with a partition wall and a method for forming a substrate with a partition wall wherein a flat and uniform colored layer is formed in each pixel without defects such as a color mixture and a color omission.

In addition, the present invention is to provide a substrate with a partition wall and a method for manufacturing a substrate with a partition wall wherein a functional layer is uniform and adhesion between a partition wall and a functional layer is good, in the case where a functional layer is formed on a partition wall.

### SUMMARY OF THE INVENTION

Hereinafter, the structure of the present invention for solving the above stated problem is described below.

A first aspect of the present invention is as follows. A substrate with a partition wall pattern, including a substrate, and a partition wall pattern formed on a predetermined position of the substrate, the partition wall pattern comprising a material including a fluorine compound, wherein a ratio of a detected intensity of a fragment ion of F⁻ (M/Z=19) to total detected intensity of all minus ions is 25%-60% in the case where analysis of minus ions of an upper surface of the partition wall is performed using a time-of-flight secondary ion mass spectrometry (TOF-SIMS).

A second aspect of the present invention is as follows. The substrate with a partition wall pattern according to the first aspect of the present invention, wherein a ratio of a detected intensity of a fragment ion of F⁻ (M/Z=19) to total detected intensity of all minus ions is equal to or less than 10% in the case where analysis of minus ions of a part is performed using a time-of-flight secondary ion mass spectrometry (TOF-SIMS), and wherein the part is a surface region of the substrate, the surface region being surrounded by the partition wall.

A third aspect of the present invention is as follows. A substrate with a partition wall pattern, including a substrate, and a partition wall pattern formed on a predetermined position of the substrate, the partition wall pattern comprising a material including a fluorine compound, wherein a ratio of a detected intensity of a fragment ion of F⁻ (M/Z=19) to total detected intensity of all minus ions is equal to or less than 10% in the case where analysis of minus ions of a part of the partition wall is performed using a time-of-flight secondary ion mass spectrometry (TOF-SIMS), and wherein the part means a region which is equal to or lower than 90% of the partition wall height from the substrate side.

A fourth aspect of the present invention is as follows. The substrate with a partition wall pattern according to the third aspect of the present invention, wherein a ratio of a detected intensity of a fragment ion of F⁻ (M/Z=19) to total detected intensity of all minus ions is equal to or less than 10% in the case where analysis of minus ions of a part is performed using a time-of-flight secondary ion mass spectrometry (TOF-SIMS), and wherein the part is a surface region of the substrate, the surface region being surrounded by the partition wall.

A fifth aspect of the present invention is as follows. A substrate with a partition wall pattern, including a substrate, a partition wall pattern formed on a predetermined position of the substrate, the partition wall pattern comprising a material including a fluorine compound, and a colored layer comprising a color ink, the layer being in a region surrounded by the partition wall pattern, wherein a ratio of a detected intensity of a fragment ion of F⁻ (M/Z=19) to total detected intensity of all minus ions is equal to or less than 20% in the case where analysis of minus ions of an upper surface of the partition wall is performed using a time-of-flight secondary ion mass spectrometry (TOF-SIMS), and wherein the color ink is not provided on the upper surface of the partition wall.

A sixth aspect of the present invention is as follows. The substrate with a partition wall pattern according to the fifth aspect of the present invention, wherein a functional layer is provided on both the partition wall and the colored layer.

A seventh aspect of the present invention is as follows. A substrate with a partition wall pattern, including a substrate, a partition wall pattern formed on a predetermined position of the substrate, the partition wall pattern comprising a material including a fluorine compound, and a colored layer comprising a color ink, the layer being in a region surrounded by the partition wall pattern, wherein a ratio of a detected intensity of a fragment ion of F⁻ (M/Z=19) to total detected intensity of all minus ions is equal to or less than 10% in the case where analysis of minus ions of a part of the partition wall is performed using a time-of-flight secondary ion mass spectrometry (TOF-SIMS), wherein the part means a region which is equal to or lower than 90% of the partition wall height from the substrate side, and wherein the color ink is not provided on the partition wall.

An eighth aspect of the present invention is as follows. The substrate with a partition wall pattern according to the seventh aspect of the present invention, wherein a functional layer is provided on both the partition wall and the colored layer.

A ninth aspect of the present invention is as follows. A method for manufacturing a substrate with a partition wall pattern, the method including forming a pattern of a partition wall material including a fluorine compound on a predetermined position of a substrate, irradiating the pattern of the partition wall material with ionizing radiation, and forming a partition wall by heating and curing the pattern of the partition wall material irradiated with ionizing radiation at a temperature of 180 degrees Celsius or less.

A tenth aspect of the present invention is as follows. The method for manufacturing a substrate with a partition wall pattern according to the ninth aspect of the present invention, wherein a ratio of a detected intensity of a fragment ion of F⁻ (M/Z=19) to total detected intensity of all minus ions is 25%-60% in the case where analysis of minus ions of an upper surface of the formed partition wall is performed using a time-of-flight secondary ion mass spectrometry (TOF-SIMS)

An eleventh aspect of the present invention is as follows. The method for manufacturing a substrate with a partition wall pattern according to the ninth aspect of the present invention, wherein a ratio of a detected intensity of a fragment ion of F⁻ (M/Z=19) to total detected intensity of all minus ions is equal to or less than 10% in the case where analysis of minus ions of a part of the formed partition wall is performed using a time-of-flight secondary ion mass spectrometry (TOF-SIMS), and wherein the part means a region which is equal to or lower than 90% of the partition wall height from the substrate side.

A twelfth aspect of the present invention is as follows. The method for manufacturing a substrate with a partition wall pattern according to the ninth aspect of the present invention, further including forming a colored layer by a color ink after forming the partition wall.

A thirteenth aspect of the present invention is as follows. The method for manufacturing a substrate with a partition wall pattern according to the ninth aspect of the present invention, further including forming a colored layer by a color ink after forming the partition wall, wherein the color ink is not provided on the partition wall pattern.

A fourteenth aspect of the present invention is as follows. The method for manufacturing a substrate with a partition wall pattern according to the ninth aspect of the present invention, further including forming a colored layer by a color ink after forming the partition wall, and washing surfaces of the partition wall and the colored layer after forming the colored layer.

A fifteenth aspect of the present invention is as follows. The method for manufacturing a substrate with a partition wall pattern according to the ninth aspect of the present invention, further including forming a colored layer by a color ink after forming the partition wall, and washing surfaces of the partition wall and the colored layer after forming the colored layer, wherein a ratio of a detected intensity of a fragment ion of F⁻ (M/Z=19) to total detected intensity of all minus ions is equal to or less than 20% in the case where analysis of minus ions of an upper surface of the partition wall after washing the surfaces is performed using a time-of-flight secondary ion mass spectrometry (TOF-SIMS).

A sixteenth aspect of the present invention is as follows. The method for manufacturing a substrate with a partition wall pattern according to the ninth aspect of the present invention, further including forming a colored layer by a color ink after forming the partition wall, and washing surfaces of the partition wall and the colored layer after forming the colored layer, wherein a ratio of a detected intensity of a fragment ion of F⁻ (M/Z=19) to total detected intensity of all minus ions is equal to or less than 10% in the case where analysis of minus ions of a part of the partition wall after washing the surfaces is performed using a time-of-flight secondary ion mass spectrometry (TOF-SIMS), and wherein the part means a region which is equal to or lower than 90% of the partition wall height from the substrate side.

A seventeenth aspect of the present invention is as follows. A method for manufacturing a substrate with a partition wall, the method including forming a pattern of a partition wall material including a fluorine compound on a predetermined position of a substrate, forming a colored layer by injecting a color ink in a region surrounded by the pattern of the partition wall, and performing a surface washing after the partition wall and the colored layer are formed.

An eighteenth aspect of the present invention is as follows. The method for manufacturing a substrate with a partition wall according to the seventeenth aspect of the present invention wherein the color ink is not provided on an upper surface of the partition wall pattern after forming the colored layer by the color ink.

A nineteenth aspect of the present invention is as follows. The method for manufacturing a substrate with a partition wall according to the seventeenth aspect of the present invention, wherein a ratio of a detected intensity of a fragment ion of F⁻ (M/Z=19) to total detected intensity of all minus ions is equal to or less than 20% in the case where analysis of minus ions of an upper surface of the partition wall after surface washing is performed using a time-of-flight secondary ion mass spectrometry (TOF-SIMS).

A twentieth aspect of the present invention is as follows. The method for manufacturing a substrate with a partition wall according to the seventeenth aspect of the present invention, wherein a ratio of a detected intensity of a fragment ion of F⁻ (M/Z=19) to total detected intensity of all minus ions is equal to or less than 10% in the case where analysis of minus ions of a part of the partition wall after the surface washing is performed using a time-of-flight secondary ion mass spectrometry (TOF-SIMS), and wherein the part means a region which is equal to or lower than 90% of the partition wall height from the substrate side.

### BRIEF DESCRIPTION OF THE DRAWINGS

FIG. 1 is an explanatory diagram of a substrate with a partition wall of the present invention.

FIG. 2 is an explanatory diagram of an example of a method for manufacturing a substrate with a partition wall of the present invention.

FIG. 3 is an explanatory diagram of an example of a method for manufacturing a substrate with a partition wall of the present invention.

### DETAILED DESCRIPTION OF THE INVENTION

Hereinafter, the present invention is described in more detail referring to the diagrams.

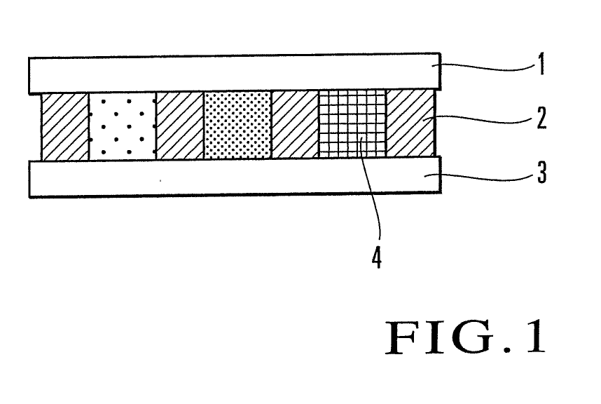

FIG. 1 is a cross-sectional diagram of an example of a substrate with a partition wall pattern of the present invention. A protective layer 1, a partition wall 2 and a colored layer (a pixel) 4 are shown in the diagram.

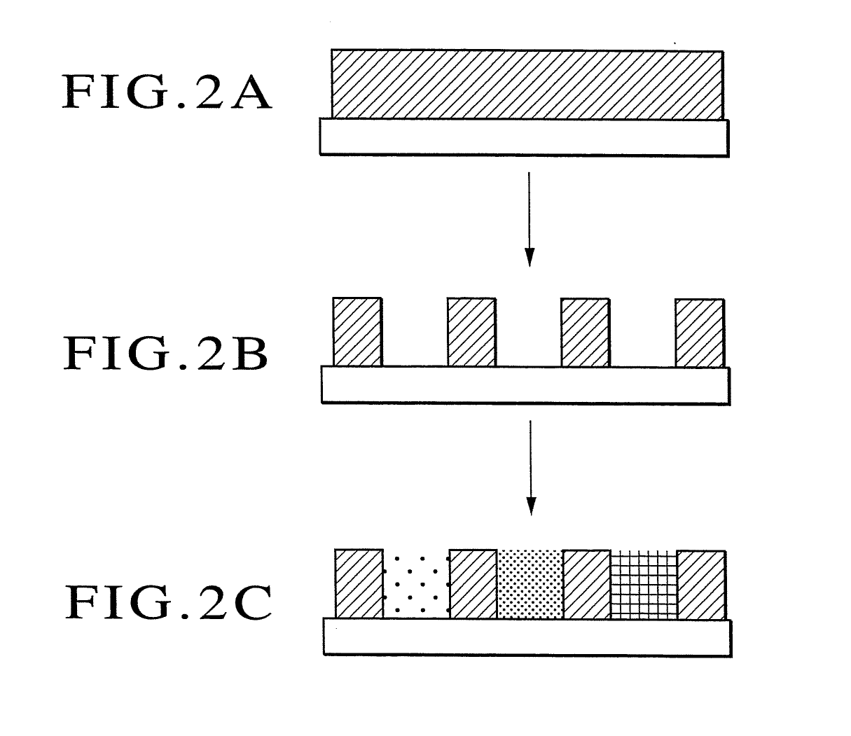

FIG. 2 is an example of a method for manufacturing a substrate with a partition wall pattern. FIG. 2 shows the following steps:

(a) a step of applying a partition wall material to the entire surface of a substrate;

(b) a step of forming a pattern of a partition wall;

(c) a step of forming a colored layer in an opening of a partition wall in the case where a colored layer is formed.

Here, respective colored layers formed in respective openings between partition walls are pixels.

In the present invention, in the case where a colored layer is formed in a region surrounded by partition wall patterns, factors which generate a defect such as a color mixture and a white omission were studied.

The following results were found:

It is most preferable that a partition wall has an ink-repellent property by making a fluorine compound disproportionately and mainly exist in an upper surface of a partition wall; and

A color mixture and a color omission are not generated and flatness of a pixel is improved when a ratio of detected intensity of a fragment ion of F⁻ (M/Z=19) to detected intensity of all minus ions is within a specific range in the case where a minus ion analysis by a time-of-flight secondary ion mass spectrometry (TOF-SIMS) is performed for an upper surface of a partition wall.

That is, it is desirable that a ratio of a detected intensity of a fragment ion of F⁻ (M/Z=19) to total detected intensity of all minus ions be 25%-60% in the case where analysis of minus ions of an upper surface of the formed partition wall is performed using a time-of-flight secondary ion mass spectrometry (TOF-SIMS). In the case where the ratio of an upper surface of the partition wall pattern is within this range, if a colored layer is formed by injecting a color ink, very flat pixels without a color mixture and a color omission can be formed.

In addition, it is desirable that a ratio of a detected intensity of a fragment ion of F⁻ (M/Z=19) to total detected intensity of all minus ions be equal to or less than 10% in the case where analysis of minus ions of a part is performed using a time-of-flight secondary ion mass spectrometry (TOF-SIMS) wherein the part is a surface region of the substrate, the surface region being surrounded by the partition wall. In the case where the ratio is within the above range, pixels without a color omission can be formed.

Further, it is desirable that a ratio of a detected intensity of a fragment ion of F⁻ (M/Z=19) to total detected intensity of all minus ions is equal to or less than 10% in the case where analysis of minus ions of a part of the partition wall is performed using a time-of-flight secondary ion mass spectrometry (TOF-SIMS) wherein the part means a region which is equal to or lower than 90% of the partition wall height from the substrate side. It is preferable that a partition wall except for an upper surface of the partition wall does not have a high ink-repellent property. This is because a problem such as a color omission occurs in the case where an ink is injected. In addition, if an ink-repellent property of an inner part of a partition wall is high, adhesion between a partition wall and a substrate is reduced. Therefore, in view of this point, the ratio is also preferably within the above range. In addition, in the case where an ink-repellent agent is included inside of a partition wall, the agent tends to move mainly to the upper part of a partition wall during a process of manufacturing the partition wall. Therefore, a ratio of detected intensity of F⁻ (M/Z=19) located near a substrate to detected intensity of all minus ions located near a substrate is lower than a ratio of detected intensity of F⁻ (M/Z=19) located at the bottom 90% part of the partition wall to detected intensity of all minus ions located at the bottom 90% part of the partition wall.

In addition, in the case where a partition wall does not have an ink-repellent property at all, a shape of a colored layer may become concave-shaped. Therefore, it is preferable that a ratio of detected intensity of a fragment ion of F⁻ (M/Z=19) to detected intensity of all minus ions be 0.1-5%.

In the case where the ratio is within the above range, a color mixture does not occur. One of the methods for checking whether the ratio is within the above range or not is to check whether a color ink is attached to an upper surface of a partition wall.

Examples of checking methods are to check a component, the component included in a color ink, and the component not included in upper part of a partition wall. Examples of the components are elements or organic functional groups. However, the components are not limited to these.

Any analysis method can be used as long as a component can be checked. Examples of analysis methods include TOF-SIMS, EDX (energy dispersive X-ray fluorescence analysis), XPS (X-ray electron spectroscopy analysis) and ICP emission analysis.

For example, in the case where a partition wall does not include Cu element and a color ink includes Cu element, checking can be performed by an element analysis of Cu located at an upper part of a partition wall.

In addition, for example, in the case where a partition wall does not include a benzene ring and a color ink includes a benzene ring, checking can be performed by analyzing whether a benzene ring exists or not.

In addition, in the case where a colored layer is formed, it is preferable that an upper surface of a partition wall has a certain degree of ink-repellent property. However, it is preferable that an upper surface of a partition wall has a low ink-repellent property after a colored layer is formed. In the case where a functional layer such as an overcoat layer or a conductive layer is formed on a partition wall, if an upper surface of a partition wall has a high ink-repellent property, the following problem occurs: a film peeling of a functional layer occurs because a functional layer becomes non-uniform or adhesion between a partition wall and a functional layer is reduced.

That is, it is preferable that a ratio of detected intensity of a fragment ion of F⁻ (M/Z=19) to detected intensity of total detected intensity of all minus ions be equal to or less than 20% in the case where analysis of minus ions of an upper surface of the partition wall after a colored layer formation is performed using a time-of-flight secondary ion mass spectrometry (TOF-SIMS). More preferably, it is 3-20%.

In addition, a ratio of a detected intensity of a fragment ion of F⁻ (M/Z=19) to total detected intensity of all minus ions is equal to or less than 10% in the case where analysis of minus ions of a part of the partition wall is performed using a time-of-flight secondary ion mass spectrometry (TOF-SIMS), wherein the part means a region which is equal to or lower than 90% of the partition wall height from the substrate side. More preferably, the ratio is 0.1-5%. This is because adhesion between a partition wall and a substrate is reduced when an ink-repellent property at an inner part of a partition wall is too high.

Here, a colored layer can be a product made of a color material ink of red, green, blue or the like, or can be a product made of a light emitting material ink of red, green, blue or the like.

In the case where a colored layer is made of a color material ink, the present invention can be used for a color filter for a liquid crystal display device or an electroluminescence display device.

In addition, in the case where a colored layer is made of a light emitting material ink, the present invention can be used for an electroluminescence display device.

In addition, the color material or the light emitting material can have other colors such as cyan, magenta, yellow and purple, other than red, green and blue. Besides, a mixed color thereof can be used.

In the case where the present invention is used for a liquid crystal display device, a transparent conductive layer and an oriented film layer can be sequentially formed on a partition wall and a colored layer. For example, such a device faces a counter substrate with an electrode such as a thin film transistor via a liquid crystal layer. Thereby, a liquid crystal display device is manufactured. In addition, if necessary, a protective layer 4 can be formed on the color filter.

In the case of an electroluminescence display device, a conductive layer, a protective layer and the like can be sequentially formed on a partition wall and a colored layer.

A well-known substrate material such as a glass substrate, a quartz substrate and a plastic substrate can be used for a substrate. A transparent substrate is preferably used. A glass substrate among them is superior in transparency, strength, heat resistance and weatherability.

Hereinafter, a partition wall and a method for forming a partition wall are described in detail. In the present invention, it is preferable that a height of a partition wall be equal to or more than 1.0 μm. More preferably, it is 1.5 μm-5 μm. In the case where a height of a partition wall is less than 1.0 μm, a color mixture easily occurs. In the case where a partition wall is too high, it is difficult to form a fine partition wall. Further, a step between a partition wall and a colored layer increases. Therefore, it is not preferable that a partition wall be too high.

It is preferable that a partition wall is made of a resin composition including an ink-repellent agent. Examples of ink-repellent agents include a silicon system material and fluorine system material. However, a fluorinated compound is preferably used.

Especially, in the case where a partition wall is formed by a photolithography, a photosensitive resin composition can be used.

In addition, the present invention is used for a display device and it is preferable that a substrate with a partition wall has a light shielding property. In particular, when a light shielding material is included in a partition wall material, a substrate with a partition wall can have a light shielding property.

In the present invention, a method for forming a partition wall is not especially limited, and a partition wall can be formed by a well-known method such as a photolithography, a printing method and a transfer method. A photolithography is preferable in view of productivity, formation of partition wall or the like.

In addition, a partition wall 2 can be a single layer structure or can be a multilayer structure including two or more layers. In addition, the number of manufacturing processes in the case of a single layer structure is one less. Further, a position adjustment is not necessary in the case of a single layer structure. Therefore, a single layer structure is preferable.

Here, it is important that ratios of a fragment ion of F⁻ at an upper surface of a partition wall, at the bottom 90% part of a partition wall and at an opening part (a substrate surface) surrounded by a partition wall are within the above ranges.

Adjustment of a detected intensity of a fragment ion of F⁻ at a partition wall is shown in the following examples. The adjustment can be performed by adjustment of an amount of a fluorine compound included in a partition wall forming composition, by adjustment of a degree of a reduced pressure and a concentration of oxygen during a burning process at the time of a partition wall formation, by adjustment of a burning temperature and the like.

In addition, adjustment of a detected intensity of a fragment ion of F⁻ at a substrate surface can be performed by the following methods: adjustment of a degree of a reduced pressure or a burning temperature during a burning process at the time of a partition wall formation; an inactive atmosphere is used for a burning atmosphere; curing process by irradiation with ultraviolet ray is provided; and adjustment of a condition of a washing process or the like.

Next, one example of a method for forming a partition wall which uses photolithography, is described.

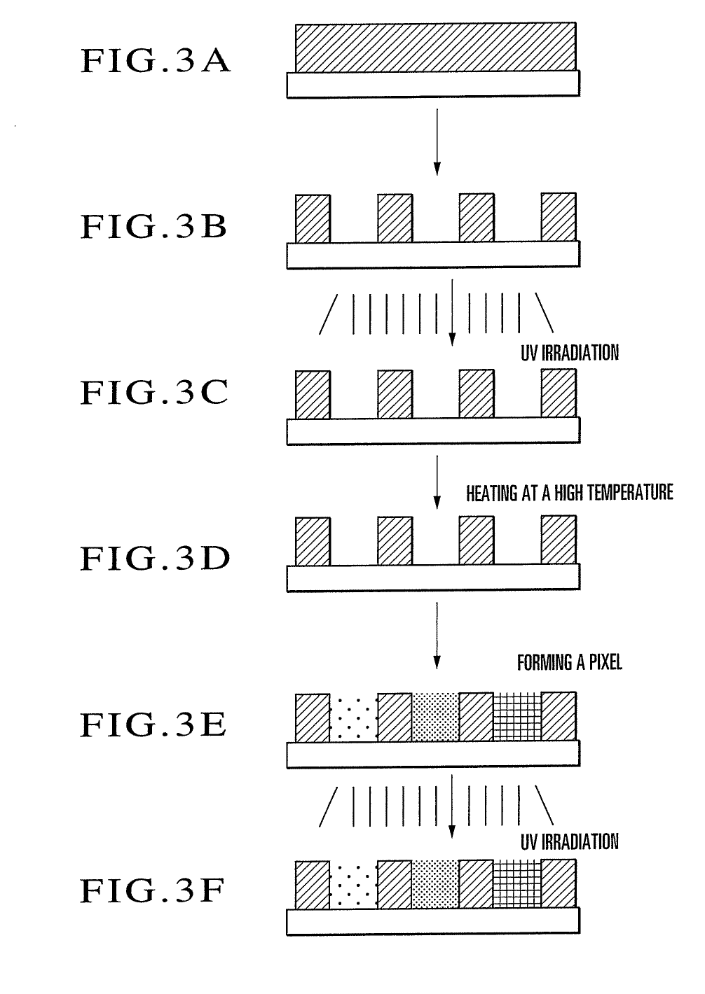

In a process for applying a photosensitive resin composition including a material capable of providing an ink-repellent property to a substrate, a negative type photosensitive resin composition including an ink-repellent agent (this is described later) is uniformly applied to a properly washed substrate using a well-known application apparatus such as a slit die coater and a spin coater (See FIG. 3(a)). Thereafter, a reduced pressure-drying process or a prebaking process can be performed in order to remove a solvent component if necessary. In this case, if a fluorine system ink-repellent agent is used, the agent dispersed in a coated film gradually moves toward a surface of a coated film. A segregation state of an ink-repellent agent changes according to time and conditions, wherein the time is from a coating to a perfect solidification of a coated film through a solvent vaporization. Therefore, it is desirable that a time interval from a coating to a reduced pressure-drying or a prebaking and the conditions are kept constant.

In a process for forming a partition wall pattern, an exposure apparatus and a photomask are used, and a partition wall pattern can be formed by a conventional well-known exposure/development method. (See FIG. 3 (b))

In a process for curing the partition wall pattern by irradiation of an ultraviolet ray, after a partition wall is cured by ionization radiation from an upper part of a substrate, heat curing can be performed. (See FIG. 3(c)) As for ionization radiation, for example, a partition wall can be cured with an ultraviolet ray of 200-500 nm or the like. As for a light source of ionization radiation, since a lot of photosensitive resins are sensitive to a wavelength region of 200-400 nm, it is especially preferable that the light source has at least one spectrum peak within the wavelength region. In addition, a light source which emits light of a wavelength (for example, 200 nm or less), the light promoting decomposition of an ink-repellent agent, is not preferable because the light reduces an ink-repellent property at a partition wall surface while a substrate surface corresponding to an opening is polluted with a decomposed ink-repellent agent. A high pressure mercury lamp or a metal halide lamp is especially preferable as a light source. As for an exposure amount of irradiation light, if ultraviolet cross-link is insufficient, a partition wall has a poor resistance against a solvent of a color ink in the case of a colored layer formation, thereby a partition wall surface may become rough. Therefore, it is preferable that an exposure amount is equal to or more than 100 mJ/cm² at 245 nm and is equal to or more than 500 mJ/cm² at 365 nm. In the present invention, in this process, scattering due to a thermal-decomposition and bleeding out of an ink-repellent agent is controlled as much as possible. Further, a partition wall is sufficiently cured so that a partition wall surface does not become rough in the case of a colored layer formation. Thereby, a color mixture or a color omission of a pixel in the case where a colored layer is formed by an ink jet can be prevented.

In addition, in the case where a partition wall made of a photosensitive resin composition including the ink-repellent agent is a light shielding layer having a light shielding property, the following phenomenon may occur: a partition wall surface is cured by an ultraviolet irradiation by a high pressure mercury lamp or a metal halide lamp while an inner part of a partition wall is not cured due to a light shielding effect. In such a case, a heat curing process at less than 180 degrees Celsius can be additionally provided. (See FIG. 3(d)) Examples of heating processes include heating by a convection oven, a hot plate, a halogen heater, and an IR oven, however the examples are not especially limited.

However, in the case where heating at 180 degrees Celsius or more is performed, even if a partition wall surface is cured with an ultraviolet ray by a high pressure mercury lamp or a metal halide lamp in a previous process, scattering or bleed out due to a thermal-decomposition of an ink-repellent agent on a substrate surface corresponding to an opening surrounded by partition walls is observed. Therefore, in the case where a colored layer is formed by an ink jet, a color omission or a degradation of flatness is badly caused. Therefore, it is desirable that heat curing be performed at lower than 180 degrees Celsius.

In addition, in the case where a process of an ultraviolet ray irradiation is not performed, heat curing at 180 degrees Celsius or more is necessary (however this depends on a resin composition). Therefore, scattering or bleeding out due to thermal-decomposition of an ink-repellent agent may occur on a substrate surface corresponding to an opening of a partition wall.

For example, a negative type photosensitive resin composition can be used for a photosensitive resin composition. A photosensitive resin composition is formed by appropriately combining the following respective components so as to be sensitive to a wavelength region of irradiation light. Main components of a photosensitive resin composition are a binder resin, a compound having a free-radical polymerization property, a photoinitiator, a solvent and an ink-repellent agent. A photosensitive resin compound includes a light shielding material if necessary.

First of all, a thermosetting resin having an alkali-solubility is preferable for a binder resin. In particular, cresol - novolac resin, polyvinyl phenol resin, acrylic resin, methacrylic resin and the like can be used. The above binder resin can be used alone or can be used as a mixed binder resin including two or more of the above binders. In addition, such a resin can include a melamine derivative and a photo-acid-generating agent in order to promote a curing property at a low temperature. Any melamine derivative can be used as long as a melamine derivative has a methylol group or a methoxymethyl group. However, a melamine derivative having a good solubility in a solvent is especially preferred.

A photo-acid-generating agent promotes a dehydration reaction and a cross-linking reaction between a melamine derivative and a binder resin by an action of an acid generated in the case where an exposure process is performed. A photo-acid-generating agent having a good solubility in a solvent is especially preferable. In particular, the following materials can be used:

diaryl iodonium such as diphenyliodonium, ditrill iodonium, phenyl (4-anisyl) iodonium, bis (3-nitrophenyl) iodonium, bis (4-tert-butylphenyl) iodonium, bis (4-chlorophenyl) iodonium, bis (4-n-dodecyl phenyl) iodonium, 4-isobutylphenyl (4-trills) iodonium and 4-iso pill phenyl (4-trills) iodonium;

chloride and bromide of triaryl sulfonium such as triaryl sulfonium such as triphenyl sulfonium;

borofluoride salt, hexafluorophosphate salt, hexafluoroarsenate salt, aromatic sulfonate and tetrakis (pentafluorophenyl) borate salt;

sulfonium organic boron complex salt such as diphenyl phenacyl sulfonium (n-butyl) triphenyl borate;

triazin compound such as 2-methyl-4,6-bis trichloromethyl triazin, 2-(4-methoxyphenyl)-4,6- bis trichloromethyl triazin and 2-{2-(5-methylfuran-2-yl) ethenyl}-4,6-bis (trichloromethyl)-s-triazin; and

diazo naphthoquinone compound such as 1,2-naphthoquinone diazide, 1,2-naphthoquinone diazide -4-sodium sulphonate, 1,2-naphthoquinone diazide-5-sodium sulphonate, 1,2-naphthoquinone diazide-4-sulfonate derivative and 1,2-naphthoquinone diazide-5-sulfonate derivative.

As a compound having a free-radical polymerization property, for example, a monomer and an oligomer having a vinyl group or an allyl group, and a polymer having a vinyl group or an allyl group at a terminal or side-chain thereof can be used. In particular, (meth) acrylic acid and a salt thereof, (meth) acrylic acid ester, (meth) acryl amides, maleic anhydride, maleate, itaconate, styrene, vinyl ether, vinyl ester, N-vinyl heterocycle, allyl ether, allyl ester and a derivative thereof can be used. Preferred compounds are poly-functional acrylates of comparatively low-molecular-weight such as pentaerythritol triacrylate, trimethylolpropane triacrylate, pentaerythritol tetra acrylate, ditrimethylolpropane tetra acrylate, dipentaerythritol penta and hexaacrylate. However, usable materials are not limited to these. As for a compound having a free-radical polymerization property, one kind of a compound can be used alone while a mixed material including two or more of the compounds can be used. An amount of a compound having a free-radical polymerization property can be 1-200 parts by weight per 100 parts by weight of a binder resin. More preferably, the amount is 10-150 parts by weight.

As for a photoinitiator, radicals are generated by exposure. Thereby, cross-linking of a binder resin occurs via a compound having a free-radical polymerization property.

Examples of photoinitiators are as follows:

benzophenone compounds such as benzophenone, 4,4′-bis(dimethylamino) benzophenone and 4,4′-bis(diethylamino) benzophenone;

acetophenones such as 1-hydroxycyclohexyl acetophenone, 2,2-dimethoxy-2-phenylacetophenone and 2-methyl-1-[4-(methylthio)phenyl]-2-morpholino propane-1-one;

thioxanthone derivatives such as thioxanthone, 2,4-diethyl thioxanthone, 2-isopropyl thioxanthone and 2-chlorothioxanthone;

anthraquinones such as 2-methyl anthraquinone, 2-ethylanthraquinone, 2-t-butyl anthraquinone and chloroanthraquinone;

benzoin ether derivatives such as benzoin methylic ether, benzoin ethyl ether and benzoin phenyl ether;

acyl phosphine derivatives such as phenylbis-(2,4,6-trimethylbenzoyl)-phosphine oxide;

lophine dimer such as 2-(o-chlorophenyl)-4,5-bis(4′-methylphenyl) imidazolyl dimmer:

N-arylglycine such as N-phenylglycine;

organic azide such as 4,4′-diazide chalcone; 3,3′,4,4′-tetra(tert-butyl peroxyl carboxy) benzophenone; and

quinone diazido group inclusion compounds.

As for a photoinitiator, one kind of a photoinitiator can be used alone while two or more kinds of photoinitiators which are mixed can be used. An amount of a photoinitiator can be 0.1-50 parts by weight per 100 parts by weight of a binder resin. The amount is preferably 1-20 parts by weight.

In addition, a light shielding material provides a light shielding property for a partition wall and thereby a display device is improved. As a light shielding material, a black pigment, a black dye, a carbon black, an aniline black, a black-lead, an iron black, a titanium oxide, an inorganic pigment and an organic pigment can be used. As for a light shielding material, one kind of the material can be used alone while two or more kinds of the materials which are mixed can be used.

Further, an ink-repellent agent provides an ink-repellent property against a color ink for a partition wall. An ink-repellent agent can be included beforehand in a resin composition used for a partition wall. As an ink-repellent agent, a fluorine system compound or a silicon system compound can be used. Especially, a fluorine system compound is preferably used. An example of a fluorine system compound is a fluorine-containing copolymer having a weight-average molecular weight of 10,000-100,000. The copolymer is especially preferable because the copolymer provides both a good ink-repellent property at a partition wall surface and a good affinity to ink at a substrate surface corresponding to an opening surrounded by partition walls.

Further, a resin composition used for forming a partition wall can include a compatible additive such as a leveling agent, a chain transfer agent, a stabilizer, a sensitizing dye, a surface active agent and a coupler.

Here, in the case of a minus ion analysis by a time-of-flight secondary ion mass spectrometry (TOF-SIMS), TRIFT-II apparatus (a product of PHI/EVANS) is preferably used. Measuring conditions are as follows: Ga+ is used for a primary ion; accelerating voltage is 18 kV; sample current is 2 nA; measuring area is 180 μm (in the case where measuring is performed by a RAW format); measured mass M/Z=1.7-2000; and measuring time is 2 minutes. An area including an upper surface of a partition wall or a substrate surface corresponding to an opening is measured by a method for taking all data (RAW format). Thereafter, a spectrum of an upper surface 21 of a partition wall or a substrate surface corresponding to an opening is extracted from a mapping image. Thereby, a ratio of a detected intensity of a fragment ion of F⁻ (M/Z=19) to a total detected intensity of all minus ions is calculated.

In addition, a minus ion analysis of the bottom 90% part of a partition wall is measured by the same way and is calculated after the upper 10% (10% or more) part of a partition wall is removed by polishing etc.

In the present invention, a line width of a partition wall corresponds to a line width of a partition wall used for a general color filter or a general EL element. In particular, a line width is preferably 5-100 μm. In the case where a line width is less than 5 μm, even if a lot of fluorine exists at an upper surface of a partition wall, it is difficult to prevent a color mixture from occurring, and it is also difficult to form a pattern of a partition wall by a conventional method. On the other hand, in the case where a line width of a partition wall is more than 100 μm, since quality as a liquid crystal display device is reduced, such a line width is not preferable.

Here, a time-of-flight secondary ion mass spectrometry (TOF-SIMS) can analyze an area of sub-μm—several μm with higher resolution. Therefore, TOF-SIMS is a tool especially suitable for analyzing an upper surface of a partition wall wherein a line width of a partition wall is only tens of μm.

In the present invention, it is desirable that ratios of fluorine be adjusted so as to be within the above range according to a shape of a partition wall, a width of an opening, a film thickness and a line width of a partition wall, a kind of a color ink, a temperature of an atmosphere and the like.

A colored layer can be formed by publicly known methods such as an ink jet method, a printing method, a transfer method and an electrodeposition method. However, in view of productivity, an ink jet method is preferably used. (See FIG. 3(e).)

A color ink used for a colored layer can have a well-known material such as a color agent, a thermo-setting resin and a solvent. If necessary, a color ink can have an additive such as a dispersant. As a color agent, a dye or a pigment can be used. However, a pigment dispersant is especially preferable in view of reliability such as heat resistance or weatherability. In addition, as a solvent, a water type or an organic solvent type can be used. However, an organic solvent is preferably used because an organic solvent has a high solubility in various resin compositions so that an ink can be injected by an ink jet method even if a concentration of a solid component of an ink is high.

In the case where a color filter is manufactured, a color pigment can be used as a color agent used for a colored layer.

Examples of a color pigment are as follows:

Pigment Red 9, 19, 38, 43, 97, 122, 123, 144, 149, 166, 168, 177, 179, 180, 192, 215, 216, 208, 216, 217, 220, 223, 224, 226, 227, 228, 240, Pigment Blue 15, 15:6,16, 22, 29, 60, 64, Pigment Green 7, 36, Pigment Red 20, 24, 86, 93, 108, 109, 110, 117, 125, 137, 138, 139, 147, 148, 153, 154, 166, 168, 185, Pigment Orange 36, Pigment Violet 23.

The above pigment can be used alone. In addition, two kinds of the above pigments which are mixed can be used.

As for a solvent used for a color ink, a solvent suitable for an ink jet method is preferably used. For example, a surface tension thereof is equal to or less than 40 mN/m and a boiling point thereof is equal to or more than 130 degrees Celsius. In the case where the surface tension is more than 40 mN/m, a stability of a shape of a dot at the time of injecting by an ink jet method receives a remarkably bad influence. In addition, in the case where the boiling point is less than 130 degrees Celsius, a drying property at a part near a nozzle is remarkably high, thereby a defect such as a clogging of a nozzle tends to occur.

Examples of preferable solvents are as follows:

2-methoxy ethanol, 2-ethoxyethanol, 2-butoxyethanol, 2-ethoxy ethyl acetate, 2-butoxy ethyl acetate, 2-methoxy ethyl acetate, 2-ethoxy ethyl ether, 2-(2-ethoxy ethoxy) ethanol, 2-(2-butoxy ethoxy) ethanol, 2-(2-ethoxy ethoxy) ethyl acetate, 2-(2-butoxy ethoxy) ethyl acetate, 2-phenoxyethanol and diethylene glycol dimethyl ether.

As for a solvent, one kind of a solvent can be used alone while two or more kinds of solvents which are mixed can be used, according to necessity.

As for a solvent, solubility, a temporal stability and a drying property are important. These properties are appropriately selected according to characteristics of a color agent and a binder resin.

The above-mentioned color ink can include the following binder resins: casein, gelatine, polyvinyl alcohol, carboxymethyl acetal, polyimide resin, acrylic resin, epoxy resin and melamine resin. A kind of a binder resin can be selected according to a color agent to be used. For example, an acrylic resin is preferable in the case where a heat resistance or a light resistance is needed.

A dispersant can be added to a color ink so that dispersing of a color matter in a binder is improved.

As a dispersant, the following materials can be used: polyoxyethylene alkyl ether as a non-ionic detergent;

sodium alkylbenzene sulfonate, poly fatty acid salt, fatty acid salt alkyl phosphate and tetraalkylammonium salt as an ionic surfactant; organic pigment derivative; and polyester. As for a dispersant, one kind of a dispersant can be used alone while two or more kinds of dispersants which are mixed can be used.

In the case where the present invention is used for an electroluminescence device, a light emitting material can be used for a color agent for a colored layer. As a light emitting material, there are a light emitting material of an inorganic compound and a light emitting material of an organic compound. As a light emitting material of an organic compound, there is a low molecular type and a high molecular type (a polymer type).

As the light emitting material, well-known materials can be used.

In addition, solvents and other additives can also be appropriately used.

In addition, colored layers of respective colors can be adjusted according to a height of a partition wall etc. As for colored layers of respective colors, an average film thickness of a pixel is preferably 80-120% of a height of a partition wall. More preferably, it is 90-110%. In addition, further, it is preferable that a film thickness of a pixel inside a pixel is uniform. For example, a film thickness of any part of a pixel inside one pixel is 80-120% of an average film thickness of the one pixel or is 80-120% of an average film thickness of all pixels of the same color as a color of the one pixel. More preferably, it is 90-110%.

After a colored layer is formed, a functional layer can be formed on a partition wall and a colored layer. Examples of a functional layer include an overcoat layer, a protective layer, a conductive layer and an electrode.

Here, in the case where a functional layer is formed on a partition wall and a colored layer, if an ink-repellent property of a partition wall is high, a functional layer may become non-uniform or film peeling of a functional layer may occur because adhesion between a functional layer and a partition wall is weak. Therefore, it is preferable that a fragment ion of F⁻ is within the above-mentioned range.

In order to realize such a situation, it is preferable that a fluorine compound near an upper part surface of a partition wall is removed by a surface washing process after a colored layer is formed. (See FIG. 3(f)

Examples of a surface washing process are as follows: dry processing methods such as ultraviolet irradiation, plasma exposure, corona discharge treatment and ultraviolet irradiation ozonization; and wet processing method using a washing agent, a solvent and alkali. An ultraviolet irradiation ozonization is preferable among them. Especially, UV irradiation processing by a low pressure mercury lamp including wave length 185nm and a xenon excimer lamp including wave length 172nm is preferable because an ultraviolet irradiation ozonization can be performed without feeding ozone. In the case of a low pressure mercury lamp, a distance between the lamp and a substrate is preferably 5-20 mm. In the case of a xenon excimer lamp, the distance is preferably 1-3 mm. Then, exposure amount is preferably 500-4000 mJ/cm². More preferably, it is 1000-3000 mJ/cm². Thereby, an ink-repellent agent at a surface of a partition wall can be decomposed and removed, and a fragment ion of F⁻ can be within the above-mentioned range.

In this way, a color omission and a color mixture of a colored layer (a pixel) do not occur. Further, while a colored layer is kept flat, adhesion between a partition wall and a function layer is kept properly. In addition, a uniform functional layer can be formed.

A substrate with a partition wall can be provided, wherein a flat and uniform colored layer can be formed in each pixel without defects such as a color mixture and a color omission.

### Examples

Hereinafter, the present invention is described in more detail using examples and comparative examples. However, the present invention is not limited to these examples.

### Example 1

### Forming a Partition Wall

A photosensitive resin composition was prepared by using materials having the following composition ratio. The materials are sufficiently kneaded by three rollers. Non-alkali glass (“#1737”, manufactured by Corning Inc.) was used as a substrate. The photosensitive resin was applied to the substrate. Thereafter, the substrate was pre-baked for 2 minutes at 90 degrees Celsius. Thereby, a film having a thickness of 2.0 μm was formed.

### [Photosensitive Resin Composition]

| | |
|---|---|
| cresol - novolac resin “EP4050G” (a product of | 20 parts by weight |
| Asahi Organic Chemicals Industry Co., Ltd) | |
| cyclohexanone | 80 parts by weight |
| carbon pigment “MA-8” (a product of | 23 parts by weight |
| Mitsubishi materials corporation) | |
| dispersing agent “Solsperse 5000” (a product | 1.4 parts by weight |
| of Zeneca) | |
| radical-polymerizable compound “Trimethylolpro- | 5 parts by weight |
| pane triacrylate” (a product of Osaka Organic | |
| Chemical Industry Ltd.) | |
| photoinitiator “IRGACURE 369” (a product of Ciba | 2 parts by weight |
| specialty Chemicals) | |
| fluorine compound “F179” (a product of DIC Cor- | 0.5 parts by weight |
| poration: Weight average molecular weight 10000) | |

Thereafter, exposure was performed by using a photomask having a lattice pattern of 35 μm line width, wherein irradiation with an ultraviolet ray of 100 mj/cm² was performed by an ultra-high pressure mercury lamp. Then, development processing was performed.

Next, an ultraviolet ray irradiation processing of 1000 mJ/m² was performed by a high pressure mercury vapor lamp. Thereafter, heat processing was performed for 20 minutes at 160 degrees Celsius in a hot air type incineration kiln. In this way, a substrate with a partition wall was obtained.

### Example 2

A substrate with a partition wall was prepared by almost in the same way as example 1. However, an ultraviolet irradiation process was not performed. The process was heated for 20 min. at 230 degrees Celsius in a hot air type incineration kiln which was filled with nitrogen so that the atmosphere was an inactive gas including 10% of oxygen.

### Example 3

A substrate with a partition wall was prepared by almost in the same way as example 1. However, an ultraviolet irradiation process was not performed. The substrate was heated for 20 min. at 160 degrees Celsius by a hot plate in a chamber of a reduced pressure of 75,000 Pa, pressure in the chamber being reduced by a dry type pump.

### Examples 4-6

Substrates with partition walls of examples 4-6 were prepared by the same method as examples 1-3 except that an amount of fluorine compound “F179” (a product of DIC Corporation: Weight average molecular weight 10000) in the photosensitive resin composition was 0.3 parts by weight.

### Comparative Example 1

A substrate with a partition wall was prepared in the same method as example 1 except that an ultraviolet irradiation processing was not performed and the substrate was heated for 20 min. at 230 degrees Celsius in a hot air type incineration kiln.

### Comparative Example 2

A substrate with a partition wall was prepared in the same way as example 1 except that an amount of fluorine compound “F179” (a product of DIC Corporation: Weight average molecular weight 10000) in the photosensitive resin composition was 0.1 parts by weight.

Next, as for the substrates with partition walls, minus ions of an upper surface of a partition wall and minus ions of a glass surface corresponding to an opening to be printed were analyzed. In this case, TOF-SIMS was used. A ratio (F⁻ %) of a detected intensity of a fragment ion of F⁻ (M/Z=19) to total detected intensity of all minus ions was calculated and shown in Table 1.

In addition, a 10% film thickness upper part of a partition wall was scraped off using SAICAS NN type (a product of DAIPLA WINTES CO., LTD). Thereby, an inner part of a partition wall was exposed. This exposed surface was analyzed in the same way.

### Preparing a Color Ink

0.75 parts by weight of azobis isobutyl nitril was added to the following composition in a nitrogen atmosphere. Thereafter, acryl copolymer resin was obtained by a chemical reaction thereof for 5 hours at 70 degrees Celsius.

| | |
|---|---|
| methacrylic acid | 20 parts by weight |
| methyl methacrylate | 10 parts by weight |
| butylmethacrylate | 55 parts by weight |
| hydroxyethyl methacrylate | 15 parts by weight |
| butyl lactate | 300 parts by weight |

A diluted solution of the acryl copolymer resin in which the ratio of the acryl copolymer to the entire solution was 10 weight % was obtained by dilution using propylene glycol methyl ether acetate.

19.0 g of color pigments and 0.9 g of polyoxyethylene alkyl ether as a dispersing agent were added to 80.1 g of this diluted solution. These were kneaded by three rollers. Thereby, respective colored varnishes of red, green and blue were obtained. In addition, pigment red 177 (anthraquinone system) as a red pigment, pigment green 36 (copper phthalocyanine system) as a green pigment and pigment blue 15 (copper phthalocyanine system) were respectively used.

The obtained respective colored varnishes were mixed with propylene glycol methyl ether acetate so that concentrations of the color pigments were 12-15 weight % and viscosity was 15 cps. Thereby, colored inks of red, green and blue were obtained.

### Manufacturing a Color Filter

Respective pixel patterns of a red colored layer (R), a green colored layer (G) and a blue colored layer (B) were formed in openings surrounded by partition walls using an ink jet printing apparatus having heads of 12 pl and 180 dpi and using the above three colored inks as pigments.

After a colored ink was injected, firstly, a solvent was evaporated by heating process for 2 min. and at 90 degrees Celsius using a hot plate. Next, the ink was heated for 30 min. at 230 degrees Celsius in a hot air type incineration kiln, thereby the ink was cured. In this way, pixel patterns were obtained.

Color filters obtained in examples 1-6 were excellent color filters without non-uniform color wherein colored layers were flat and colored layers did not have color mixtures and color omissions. On the other hand, a color filter in comparative example 1 had a colored layer with a defect of color omission wherein a shape of a colored layer was convex-shaped and non-uniform color was observed. In addition, in comparative example 2, many defects of a color mixture occurred.

In addition, color ink components on a partition wall were analyzed. TOF-SIMS analysis of five random parts of a partition wall was respectively performed. Thereby, a fragment ion of Cu⁺ showing existence of the green ink and the blue ink and a fragment ion of C₂₈H₁₆O₄N₂ showing existence of the red ink were checked. The results are shown in Table 2.

TABLE 1

| | F⁻ at | | F⁻ at inner part of | |
|---|---|---|---|---|
| | upper | F⁻ at | partition wall when | |
| | surface of | surface of | upper 10% of | |
| | partition | substrate | partition wall was | Quality of |
| | wall (%) | (%) | scraped off (%) | color filter |
| Example 1 | 43 | 6 | 5 | excellent |
| Example 2 | 48 | 5 | 4 | excellent |
| Example 3 | 53 | 7 | 4 | excellent |
| Example 4 | 32 | 2 | 2 | excellent |
| Example 5 | 35 | 2 | 2 | excellent |
| Example 6 | 39 | 3 | 2 | excellent |
| Compar- | 52 | 13 | 4 | Color omission |
| ative | | | | occurred. Col- |
| Example 1 | | | | ored layer was |
| | | | | convex-shaped. |
| Compar- | 22 | 1 | 1 | Color mixture |
| ative | | | | occurred. |
| Example 2 | | | | |

TABLE 2

| | Cu | C₂₈H₁₆O₄N₂ |
|---|---|---|
| Example 1 | Nonexistent | Nonexistent |
| Example 2 | Nonexistent | Nonexistent |
| Example 3 | Nonexistent | Nonexistent |
| Example 4 | Nonexistent | Nonexistent |
| Example 5 | nonexistent | Nonexistent |
| Example 6 | nonexistent | Nonexistent |
| Comparative Example 1 | nonexistent | Nonexistent |
| Comparative Example 2 | existent | Existent |

### Forming a Functional Layer

After a colored layer was formed, a sample obtained in the examples was irradiated with ultraviolet radiation of 3000 mJ/cm² by a low-pressure mercury lamp wherein a distance between the sample and the lamp was 10 mm. Thereby, an ink-repellent property of an upper part of a partition wall was reduced.

Next, an acryl resin system heat curing type (acid—epoxy cure type) overcoat agent was coated by a slit coater. After heating for 30 min. by an oven at 230 degree Celsius, an overcoat layer of 2 μm thickness was formed.

Before forming the overcoat layer, analysis of minus ions by TOF-SIMS was performed. In this case, an upper part of a partition wall was analyzed, and an inner part of a partition wall in the case where the upper 10% of a partition wall was scraped off was analyzed. A ratio of detected intensity of a fragment ion of F⁻ to detected intensity of all minus ions was calculated and the ratio is shown in table 3.

In addition, table 3 shows uniformity of a functional layer.

TABLE 3

| | F⁻ at upper | F⁻ at inner part of | |
|---|---|---|---|
| | surface of | partition wall in the case | Uniformity of |
| | partition | where upper 10% partition | functional |
| | wall (%) | wall was scraped off (%) | layer |
| Example 1 | 12 | 5 | Uniform |
| Example 2 | 15 | 4 | Uniform |
| Example 3 | 17 | 4 | Uniform |
| Example 4 | 6 | 2 | Uniform |
| Example 5 | 8 | 2 | Uniform |
| Example 6 | 8 | 2 | Uniform |
| Comparative | 52 | 4 | Many |
| Example 1 | | | non-uniform |
| | | | points were |
| | | | observed. |
| Comparative | 22 | 1 | Some |
| Example 2 | | | non-uniform |
| | | | points were |
| | | | observed. |

In the color filters of examples 1-6, a functional layer was uniform and a peeling of a film did not occur.

### INDUSTRIAL APPLICABILITY

The present invention can provide a substrate with a partition wall and a method for manufacturing a substrate with a partition wall, in which a substrate has a flat and uniform colored layer in each pixel without a defect such as a color mixture and a color omission.

What is claimed is:

1. A substrate comprising:
a partition wall including a partition wall pattern formed on a predetermined position of the substrate, the partition wall pattern is formed by a material including a fluorine compound,
wherein
a ratio of a detected intensity of a fragment ion of F⁻ (M/Z=19) to a total detected intensity of all minus ions is 25%-60% in the case where an analysis of minus ions of an upper surface of the partition wall is performed using a time-of-flight secondary ion mass spectrometry (TOF-SIMS).

2. The substrate according to claim 1, wherein the ratio of a detected intensity of a fragment ion of F⁻ (M/Z=19) to a total detected intensity of all minus ions is equal to or less than 10% in the case where an analysis of minus ions of a part is performed using the time-of-flight secondary ion mass spectrometry (TOF-SIMS), and, wherein the part is a surface region of the substrate, the surface region being surrounded by the partition wall.

3. A substrate comprising:
a partition wall including a partition wall pattern formed on a predetermined position of the substrate, the partition wall pattern is formed by a material including a fluorine compound,
wherein
a ratio of a detected intensity of a fragment ion of F⁻ (M/Z=19) to a total detected intensity of all minus ions is equal to or less than 10% in the case where an analysis of minus ions of a part of the partition wall is performed using a time-of-flight secondary ion mass spectrometry (TOF-SIMS), and wherein the part includes a region which is equal to or lower than 90% of the partition wall height from the substrate side.

4. The substrate according to claim 3, wherein the ratio of a detected intensity of a fragment ion of F⁻ (M/Z=19) to a total detected intensity of all minus ions is equal to or less than 10% in the case where an analysis of minus ions of a part is performed using the time-of-flight secondary ion mass spectrometry (TOF-SIMS), and wherein the part is a surface region of the substrate, the surface region being surrounded by the partition wall.

5. A substrate comprising:
a partition wall including a partition wall pattern formed on a predetermined position of the substrate, the partition wall pattern comprising a material including a fluorine compound; and
a colored layer is formed by a color ink, the layer being in a region surrounded by the partition wall pattern,
wherein
a ratio of a detected intensity of a fragment ion of F⁻ (M/Z=19) to a total detected intensity of all minus ions is equal to or less than 20% in the case where an analysis of minus ions of an upper surface of the partition wall is performed using a time-of-flight secondary ion mass spectrometry (TOF-SIMS), and wherein the color ink is not provided on an upper surface of the partition wall.

6. The substrate according to claim 5, further comprising a functional layer on both the partition wall and the colored layer.

7. A substrate comprising:
a partition wall including a partition wall pattern formed on a predetermined position of the substrate, the partition wall pattern is formed by a material including a fluorine compound; and
a colored layer comprising a color ink, the layer being in a region surrounded by the partition wall pattern,
wherein
a ratio of a detected intensity of a fragment ion of F⁻ (M/Z=19) to a total detected intensity of all minus ions is equal to or less than 10% in the case where an analysis of minus ions of a part of the partition wall is performed using a time-of-flight secondary ion mass spectrometry (TOF-SIMS), wherein the part includes a region which is equal to or lower than 90% of the partition wall height from a substrate side, and wherein the color ink is not provided on upper surface of the partition wall.

8. The substrate according to claim 7, a further comprising functional layer on both the partition wall and the colored layer.

9. A method for manufacturing a substrate with a partition wall pattern, the method comprising:
forming a pattern of a partition wall material including a fluorine compound on a predetermined position of the substrate;
irradiating the pattern of the partition wall material with ionizing radiation; and
forming a partition wall by heating and curing the pattern of the partition wall material irradiated with ionizing radiation at a temperature of 180 degrees Celsius or less.

10. The method for manufacturing a substrate with a partition wall pattern according to claim 9, wherein a ratio of a detected intensity of a fragment ion of F⁻ (M/Z=19) to a total detected intensity of all minus ions is 25%-60% in the case where an analysis of minus ions of an upper surface of the formed partition wall is performed using a time-of-flight secondary ion mass spectrometry (TOF-SIMS)

11. The method for manufacturing a substrate with a partition wall pattern according to claim 9, wherein a ratio of a detected intensity of a fragment ion of F⁻ (M/Z=19) to a total detected intensity of all minus ions is equal to or less than 10% in the case where an analysis of minus ions of a part of the formed partition wall is performed using the time-of-flight secondary ion mass spectrometry (TOF-SIMS), and wherein the part includes a region which is equal to or lower than 90% of the partition wall height from the substrate side.

12. The method for manufacturing a substrate with a partition wall pattern according to claim 9, further comprising:
forming a colored layer by a color ink after forming the partition wall.

13. The method for manufacturing a substrate with a partition wall pattern according to claim 9, further comprising:
forming a colored layer by a color ink after forming the partition wall,
wherein
the color ink is not provided on upper surface of the partition wall pattern.

14. The method for manufacturing a substrate with a partition wall pattern according to claim 9, further comprising:
forming a colored layer by a color ink after forming the partition wall, and
washing surfaces of the partition wall and the colored layer after forming the colored layer.

15. The method for manufacturing a substrate with a partition wall pattern according to claim 9, further comprising:
forming a colored layer by a color ink after forming the partition wall, and
washing surfaces of the partition wall and the colored layer after forming the colored layer,
wherein a ratio of a detected intensity of a fragment ion of F⁻ (M/Z=19) to a total detected intensity of all minus ions is equal to or less than 20% in the case where an analysis of minus ions of an upper surface of the partition wall after washing the surfaces is performed using a time-of-flight secondary ion mass spectrometry (TOF-SIMS).

16. The method for manufacturing a substrate with a partition wall pattern according to claim 9, further comprising:
forming a colored layer by a color ink after forming the partition wall, and
washing surfaces of the partition wall and the colored layer after forming the colored layer,
wherein a ratio of a detected intensity of a fragment ion of F⁻ (M/Z=19) to a total detected intensity of all minus ions is equal to or less than 10% in the case where an analysis of minus ions of a part of the partition wall after washing the surfaces is performed using a time-of-flight secondary ion mass spectrometry (TOF-SIMS), and wherein the part includes a region which is equal to or lower than 90% of the partition wall height from the substrate side.

17. A method for manufacturing a substrate with a partition wall, the method comprising:
forming a pattern of a partition wall material including a fluorine compound on a predetermined position of a substrate;
forming a colored layer by injecting a color ink in a region surrounded by the pattern of the partition wall; and
performing a surface washing after the partition wall and the colored layer are formed.

18. The method for manufacturing a substrate with a partition wall according to claim 17, wherein the color ink is not provided on upper surface of the partition wall pattern after forming the colored layer by the color ink.

19. The method for manufacturing a substrate with a partition wall according to claim 17, wherein a ratio of a detected intensity of a fragment ion of F⁻ (M/Z=19) to a total detected intensity of all minus ions is equal to or less than 20% in the case where an analysis of minus ions of an upper surface of the partition wall after the surface washing is performed using a time-of-flight secondary ion mass spectrometry (TOF-SIMS).

20. The method for manufacturing a substrate with a partition wall according to claim 17, wherein a ratio of a detected intensity of a fragment ion of F⁻ (M/Z=19) to a total detected intensity of all minus ions is equal to or less than 10% in the case where an analysis of minus ions of a part of the partition wall after the surface washing is performed using a time-of-flight secondary ion mass spectrometry (TOF-SIMS), and wherein the part includes a region which is equal to or lower than 90% of the partition wall height from the substrate side.
